(19) United States
(12) Patent Application Publication
(10) Pub. No.: US 2025/0350189 A1
(43) Pub. Date: Nov. 13, 2025

(54) INTEGRATED CONTROL CIRCUIT AND CONTROL METHOD FOR POWER DISTRIBUTION OF MULTI-CONVERTER SWITCHING POWER SUPPLY

(71) Applicant: Chengdu Monolithic Power Systems Co., Ltd., Chengdu (CN)

(72) Inventor: Xuefeng Chen, Hangzhou (CN)

(21) Appl. No.: 19/202,463

(22) Filed: May 8, 2025

(30) Foreign Application Priority Data
May 9, 2024 (CN) 202410572268.6

(51) Int. Cl. H02M 1/088; H02M 1/08; H02M 3/335

(52) U.S. Cl. CPC H02M 1/088; H02M 1/083; H02M 3/33576

(57) ABSTRACT

An integrated control circuit for a multi-converter switching power supply. Each switching converter has a primary switch and a secondary switch. The secondary switch is turned on twice in a switching cycle. A master integrated control circuit has a transmission terminal for providing a time indication pulse signal. A slave integrated control circuit has a transmission terminal for receiving the time indication pulse signal and turns on its secondary switch for a second ON-time. The second ON-time is adjusted based on the time indication pulse signal, a third duration between a start point when the primary switch is turned on and a stop point when a current flowing through the secondary switch crosses zero, and a fourth duration between the stop point and a subsequent start point.

### CROSS-REFERENCE TO RELATED APPLICATIONS

This application claims the benefit of CN application No. 202410572268.6, filed on May 9, 2024, and incorporated herein by reference.

### TECHNICAL FIELD

The present invention generally relates to electronic circuits, and more particularly but not exclusively, to integrated control circuits and associated control methods for power distribution of multi-converter switching power supplies.

### BACKGROUND

Electric power supply systems composed of several parallel-connected converters have advantages for designing power conversion systems and Universal Serial Bus (USB) standardizing systems, thus become popular in many practical applications with the dynamic power requirements. However, it requires to manage power distribution among parallel-connected converters due to the mis-matched output during operation. A good power distribution can help to improve the system's heat dispelling while ensuring efficient and reliable power system operation.

### SUMMARY

There has been provided, in accordance with an embodiment of the present disclosure, a switching power supply. The switching power supply has a first switching converter, a second switching converter, a first integrated control circuit, and a second integrated control circuit. The first switching converter has a first primary switch and a first secondary switch. The second switching converter has a second primary switch and a second secondary switch. The first and second switching converters are configured to provide an output voltage to an output node. The first integrated control circuit has a transmission terminal configured to provide a time indication pulse signal having a first level width and a second level width. The first level width represents a first duration between a first start point when the first primary switch is turned on and a first stop point when a current flowing through the first secondary switch crosses zero. The second level width represents a second duration between the first stop point and a subsequent first start point. The second integrated control circuit is configured to control the second secondary switch to be turned on twice in a switching cycle. The second integrated control circuit comprises a second transmission terminal, a first circuit, a second circuit and an ON-time control circuit. The second transmission terminal is configured to be coupled to the first transmission terminal for receiving the time indication pulse signal. The first circuit is configured to capture a third duration between a second start point when the second primary switch is turned on and a second stop point when a current flowing through the second secondary switch crosses zero. The second circuit is configured to capture a fourth duration between the second stop point and a subsequent second start point. The ON-time control circuit is configured to provide an ON-time control signal to turn on the second secondary switch for a second ON-time after the second stop point, wherein the second ON-time is adjusted so that the ratio of the fourth duration to the second duration is close to the ratio of the third duration to the first duration.

There has also been provided, in accordance with an embodiment of the present disclosure, an integrated control circuit for a switching converter with a primary switch and a secondary switch. The integrated control circuit comprises a transmission terminal, a current reference terminal and a peak comparison circuit. The transmission terminal is configured to provide a time indication pulse signal having a first level width and a second level width. The first level width represents a first duration between a first start point when the primary switch is turned on and a first stop point when a current flowing through the secondary switch crosses zero. The second level width represents a second duration between the first stop point and a subsequent first start point. The current reference terminal is configured to share a first threshold voltage with a slave control circuit. The peak comparison circuit is configured to compare a current sense signal indicative of a current flowing through the primary switch with the first threshold voltage and to provide a peak comparison signal to control the turning-off of the primary switch based on the comparison.

There has also been provided, in accordance with an embodiment of the present disclosure, an integrated control circuit for a switching converter with a primary switch and a secondary switch. The integrated control circuit comprises a transmission terminal capable of receiving a time indication pulse signal from a master control circuit, a first circuit, a second circuit and an ON-time control circuit. The time indication pulse signal has a first level width representative of a first duration and a second level width representative of a second duration. The first circuit is configured to capture a third duration between a second start point when the primary switch is turned on and a second stop point when a current flowing through the secondary switch crosses zero. The second circuit is configured to capture a fourth duration between the second stop point and a subsequent second start point. The ON-time control circuit is configured to provide an ON-time control signal to turn on the secondary switch for a second ON-time after the second stop point. The second ON-time is adjusted based on the time indication pulse signal, the third duration and the fourth duration.

There has also been provided, in accordance with an embodiment of the present disclosure, a control method for a multi-converter switching power supply for providing an output voltage. The control method comprises the following steps. A master control circuit is engaged to control a first primary switch and a first secondary switch of a first switching converter. A slave control circuit is engaged to control a second primary switch and a second secondary switch of a second switching converter. A time indication pulse signal having a first level width and a second level width is sent at a transmission terminal of the master control circuit. The first level width represents a first duration between a first start point when the first primary switch is turned on and a first stop point when a current flowing through the first secondary switch crosses zero. The second level width represents a second duration between the first stop point and a subsequent first start point. The time indication pulse signal is received at a transmission terminal of the slave control circuit. A third duration between a second start point when the second primary switch is turned on and a second stop point when a current flowing through the second secondary switch crosses zero, is captured. A fourth duration between the second stop point and a subsequent second start point is captured. An ON-time control signal is provided to turn on the second secondary switch for a second ON-time. The second ON-time is adjusted so that a first ratio of the fourth duration to the second duration is close to a second ratio of the third duration to the first duration.

### BRIEF DESCRIPTION OF DRAWINGS

The present invention can be further understood with reference to the following detailed description and the appended drawings, wherein like elements are provided with like reference numerals.

FIG. 1 schematically illustrates a block diagram of a switching power supply 100 in accordance with an embodiment of the present invention.

FIG. 2 schematically illustrates a working waveform diagram of a signal IO in accordance with an embodiment of the present invention.

FIG. 3 schematically illustrates a working waveform diagram of the switching power supply 100 operating in boundary current mode in accordance with an embodiment of the present invention.

FIG. 4 schematically illustrates a flow diagram of a method 200 of adjusting the second ON-time of the secondary switch SR2 in accordance with an embodiment of the present invention.

FIG. 5 schematically illustrates a first integrated control circuit 103A configured as a master control circuit in accordance with an embodiment of the present invention.

FIG. 6 schematically illustrates a first integrated control circuit 103B configured as a master control circuit in accordance with an embodiment of the present invention.

FIG. 7 schematically illustrates a second integrated control circuit 104A configured as a slave control circuit in accordance with an embodiment of the present invention.

FIG. 8 schematically illustrates an ON-time control circuit 406 of the slave control circuit in accordance with an embodiment of the present invention.

FIG. 9 schematically illustrates a working waveform diagram of the switching power supply 100 operating in discontinuous current mode in accordance with an embodiment of the present invention.

FIG. 10 schematically illustrates a working waveform diagram of the second switching converter 102 operating in discontinuous current mode in accordance with another embodiment of the present invention.

FIG. 11 schematically illustrates a working waveform diagram of the second switching converter 102 operating in discontinuous current mode in accordance with yet another embodiment of the present invention.

FIG. 12 schematically illustrates a flow diagram of a method 600 for a multi-converter switching power supply in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration, are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

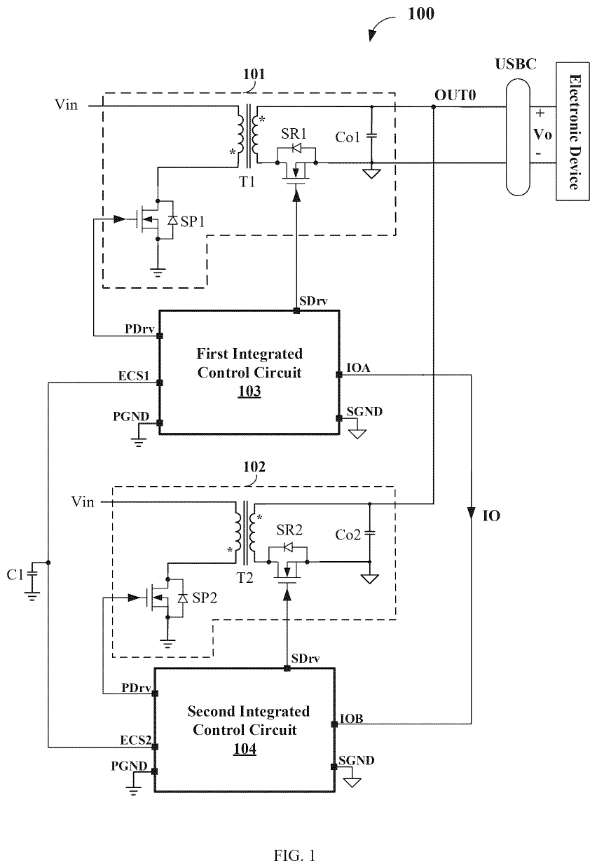

FIG. 1 schematically illustrates a block diagram of a switching power supply 100 in accordance with an embodiment of the present invention. As shown in FIG. 1, the switching power supply 100 may comprise a first switching converter 101, a second switching converter 102, a first integrated control circuit 103, a second integrated control circuit 104 and a USB port USBC that is adapted to be connected to an electrical device for providing power.

For ease of description and understanding, the first switching converter 101 and the second switching converter 102 could have the same topology. In one embodiment, both the first switching converter 101 and the second switching converter 102 are flyback converters. However, this is not intended to be limiting. In other embodiments, the first switching converter 101 and the second switching converter 102 may also be implemented with other suitable isolated switching converters, such as Forward, Half-bridge flyback, Asymmetrical half-bridge configuration, and so on. The switches in the switching converter 101 and 102 may be any controllable semiconductor devices.

In accordance with an exemplary embodiment of the present invention, the first switching converter 101 may comprise a primary switch SP1, a secondary switch SR1, a first transformer T1 having a primary winding and a secondary winding, and an output capacitor Co1. The first switching converter 101 is controlled by the first integrated control circuit 103.

In accordance with an exemplary embodiment of the present invention, the primary switch SP1 is controlled to be turned on with zero voltage technique. Before the primary switch SP1 will be turned on at zero voltage, the secondary switch SR1 is turned on twice in a switching cycle of the first switching converter 101. In detail, after the primary switch SP1 is turned off, the secondary switch SR1 is turned on for a first time. When a current flowing through the secondary switch SR1 crosses zero, the secondary switch SR1 is turned off. Subsequently, the secondary switch SR1 will be turned on again, a negative current flows through the secondary switch SR1 and the magnetized inductance of the first transformer T1. This negative current is used to discharge the output capacitance of the primary switch SP1. After the secondary switch SR1 is turned off again, the primary switch SP1 is turned on at zero voltage and the next switching cycle of the first switching converter 101 starts.

As shown in FIG. 1, the second switching converter 102 may comprise a primary switch SP2, a secondary switch SR2, a second transformer T2 having a primary winding and a secondary winding, and an output capacitor Co2. The second switching converter 102 is controlled by the second integrated control circuit 104.

In accordance with an exemplary embodiment of the present invention, the secondary switch SR2 is turned on twice in a switching cycle of the second switching converter 102, the primary switch SP2 will be turned on at zero voltage or near zero voltage, at the same time, to meet a higher power distribution requirement. In detail, after the primary switch SP2 is turned off, the secondary switch SR2 is turned on for a first time. When a current flowing through the secondary switch SR2 crosses zero, the secondary switch SR2 is turned off. Subsequently, the secondary switch SR2 will be turned on again for a second ON-time, to generate a negative current flowing through the magnetized inductance of the second transformer T2. This negative current is used to discharge the output capacitance of the primary switch SP2. After the secondary switch SR2 is turned off again, the primary switch SP2 is turned on at zero voltage or near to the zero voltage, and the next switching cycle of the second switching converter 102 starts.

As shown in FIG. 1, the first switching converter 101 is configured to receive an input voltage Vin, to convert the input voltage Vin to an output voltage Vo by controlling the primary switch SP1 and the secondary switch SR1, and to provide power for an output node OUT0. The second switching converter 102 is configured to receive the input voltage Vin, to convert the input voltage Vin to the output voltage Vo by controlling the primary switch SP2 and the secondary switch SR2, and to provide power for the output node OUT0.

In accordance with an exemplary embodiment of the present invention, the switching power supply 100 may be configured to operate in a master-slave power supply mode, and the output terminals of the first switching converter 101 and the second switching converter 102 are both coupled to the USB port USBC, to provide the output voltage Vo and double current load capability to the electronic device.

However, this is not intended to be limiting. In one embodiment, the switching power supply 100 may be configured to support two or more USB ports. The switching power supply 100 with multiple outputs will exit the master-slave power supply mode, for example, each switching converter is independently provide respective power for its corresponding USB port coupled to a corresponding electronic device.

In the example shown in FIG. 1, the first integrated control circuit 103 is configured to have a plurality of terminals. The plurality of terminals may comprise a transmission terminal IOA, a secondary drive terminal SDrv that is adapted to be coupled to a control terminal of the secondary switch SR1, a secondary reference ground SGND, a primary drive terminal PDrv that is adapted to be coupled to a control terminal of the primary switch SP1, a current reference terminal ECS1 and a primary reference ground PGND. The second integrated control circuit 104 is configured to have a plurality of terminals including a transmission terminal IOB, a secondary drive terminal SDrv that is adapted to be coupled to a control terminal of the secondary switch SR2, a secondary reference ground SGND, a primary drive terminal PDrv that is adapted to be coupled to a control terminal of the primary switch SP2, a current reference terminal ECS2 and a primary reference ground PGND. Specially, the transmission terminal IOA of the first integrated control circuit 103 is connected to the transmission terminal IOB of the second integrated control circuit 104.

In the embodiment shown in FIG. 1, the switching power supply 100 operates in the master-slave power supply mode, the first integrated control circuit 103 is configured as a master control circuit while the second integrated control circuit 104 is configured as a slave control circuit. The first integrated control circuit 103 provides a time indication pulse signal IO having a first level and a second level at the transmission terminal IOA. The time indication pulse signal IO is communicated to the transmission terminal IOB of the second integrated control circuit 104 through a connection line between the transmission terminal IOA and the transmission terminal IOB.

The current reference terminal ECS1 of the first integrated control circuit 103 is coupled to the current reference terminal ECS2 of the second integrated control circuit 104 to share a first threshold voltage VTH1. In one embodiment, the first threshold voltage VTH1 is stored in a capacitor C1. The capacitor C1 has a first terminal coupled to the current reference terminals ECS1 and ECS2, and a second terminal coupled to the primary reference ground PGND. In the master-slave power supply mode, when a first current sense signal V_{CS1} representative of a current flowing the primary switch SP1 increases to the first threshold voltage VTH1, the primary switch SP1 is turned off. When a second current sense signal V_{CS2} representative of a current flowing through the primary switch SP2 increases to the first threshold voltage VTH1, the primary switch SP2 is turned off.

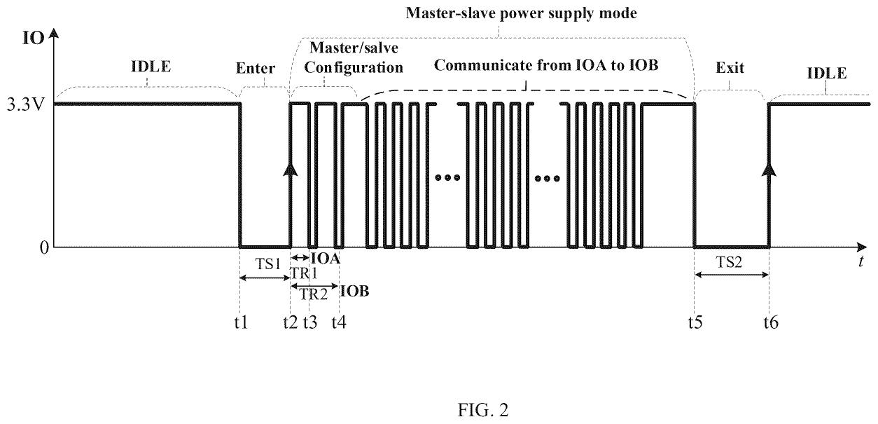

Several of details of the embodiments of configuring the switching power supply to enter the master-slave power supply mode and the configuration of the master control circuit and the slave control circuit are described with reference to FIG. 2.

FIG. 2 schematically illustrates a working waveform diagram of a signal IO in accordance with an embodiment of the present invention. It is noted that, for ease of description and understanding, the signal IO is referred as an enable signal IO outside a communication window, while the signal IO is referred as a time indication pulse signal during the communication window.

As shown in FIG. 2, before time t1, there is no communication between the transmission terminal IOA and the transmission terminal IOB. The signal IO is function as the enable signal with logic high state, which indicates an IDLE state. Then there is enter detection from time t1, when the enable signal IO is pulled down to the logic low state for a first time threshold TS1, to indicate the entering of the master-slave power supply mode. In an example, the first time threshold TS1 is not less than 50 μs and not higher than 500 ns. In other words, entering the master-slave power supply mode is identified by the first integrated control circuit 103 and the second integrated control circuit 104 in response to the duration of the logic low state of the enable signal IO reaching the first time threshold TS1.

Referring still to FIG. 2, after the identification of entering the master-slave power supply mode, the first integrated control circuit 103 and the second integrated control circuit 104 will respond. In detail, the first integrated control circuit 103 is configured to start timing from a first transition edge (i.e., time t2, from the logic low state to the logic high state of the enable signal IO) after the identification of entering the master-slave power supply mode, and is further configured as the master control circuit by providing a first pulse signal at the transmission terminal IOA, in response to the timing duration exceeding a first timing period TR1 (at time t3). The second integrated control circuit 104 is configured to start timing from the first transition edge (i.e., time t2) of the enable signal IO after the identification of entering the master-slave power supply mode, and is further configured as the slave control circuit by providing a second pulse signal at transmission terminal IOB in response to the timing duration exceeding a second timing period TR2 (at time t4).

After the second pulse signal, the communication window starts, the communication between the first integrated control circuit 103 and the second integrated control circuit 104 is enabled. In detail, during the communication window, the first integrated control circuit 103 is configured to send the time indication pulse signal IO at the transmission terminal IOA to the transmission terminal IOB of the second integrated control circuit 104. The time indication pulse signal IO has a first level and a second level. The second integrated control circuit 104 is configured to receive the time indication pulse signal IO at the transmission terminal IOB from IOA of the first integrated control circuit 103.

From time t5, the signal IO is pulled down for a second time threshold TS2, the communication window ends, there is no longer communication between the first integrated control circuit 103 and the second integrated control circuit 104. In one embodiment, exiting the master-slave power supply mode is identified by the integrated control circuits 103 and 104 in response to the duration of the logic low state of the enable signal IO reaching the second time threshold TS2. In an embodiment, the second time threshold TS2 is longer than the first time threshold TS1.

After time t6, the enable signal IO remains logic high state to indicate the IDLE state, the first integrated control circuit 103 and the second integrated control circuit 104 work independently.

The embodiment shown in FIG. 2 can be used to configure the first integrated control circuit 103 as the master control circuit and to configure the second integrated control circuit 104 as the slave control circuit. However, this is not intended to be limiting. In one embodiment, the configuration of the master control circuit and the slave control circuit can use other ways. For example, the first integrated control circuit 103 can be configured as the master control circuit by connecting a configuration terminal of the first integrated control circuit 103 to ground, and the second integrated control circuit 104 may be configured as the slave control circuit by floating a configuration terminal of the second integrated control circuit 104.

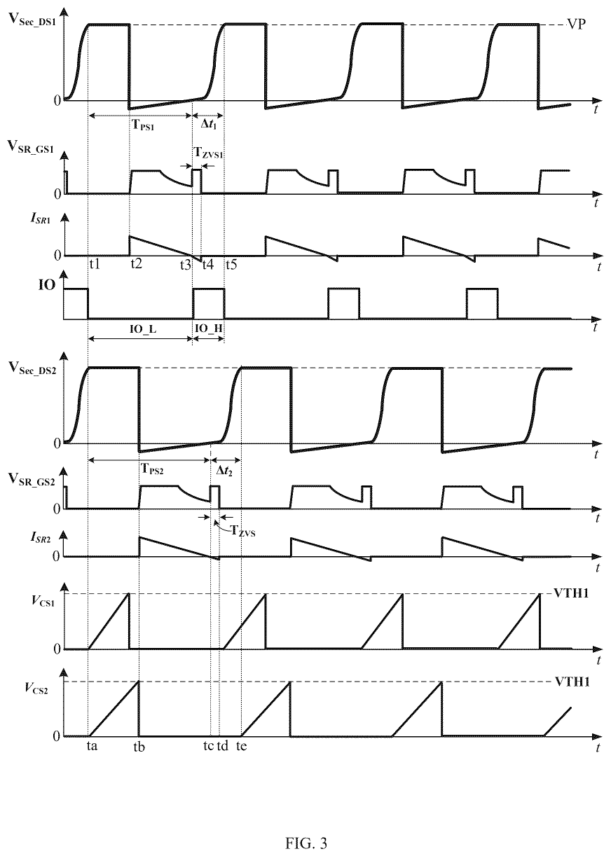

FIG. 3 schematically illustrates a working waveform diagram of the switching power supply 100 in boundary current mode in accordance with an embodiment of the present invention.

As shown in FIG. 3, from the top to the bottom, the waveforms are a voltage V_{sec_DS1} across the secondary switch SR1, a gate drive voltage V_{SR_GS1} of the secondary switch SR1, a current I_{SR1} flowing through the secondary switch SR1, the time indication pulse signal IO communicated from the transmission terminal IOA to the transmission terminal IOB, a voltage V_{sec_DS2} across the secondary switch SR2, a gate drive voltage V_{SR_GS2} of the secondary switch SR2, a current I_{SR2} flowing through the secondary switch SR2, a first current sense signal V_{CS1} and a second current sense signal V_{CS2}.

As shown in FIG. 3, the secondary switch SR1 at the secondary side is turned on twice in a switching cycle of the first switching converter 101, to achieve zero-voltage switching (ZVS) turning-on of the primary switch SP1. The secondary switch SR2 is turned on twice in a switching cycle of the second switching converter 102, to achieve ZVS or nearly ZVS turning-on of the primary switch SP2, and at the same time, to meet the power sharing requirements in the master-slave power supply mode. In addition, the first switching converter 101 and the second switching converter 102 may work non-interleaved.

For the first switching converter 101, as shown in FIG. 3, the primary switch SP1 is turned on from time t1, the current flowing through the primary switch SP1 is increased, the first current sense signal V_{CS1} increases accordingly. The voltage V_{sec_DS1} across the secondary switch SR1 is increased to its plateau voltage (labelled as VP) when the primary switch SP1 is turned on at time t1. The time when the primary switch SP1 is turned on may be referred to as a first start point, and the first start point is determined.

Referring still to FIG. 3, at time t2, the first current sense signal V_{CS1} increases to the first threshold voltage VTH1, the primary switch SP1 is turned off. The voltage V_{sec_DS1} across the secondary switch SR1 is thus decreased. When the voltage V_{sec_DS1} is decreased to reach a turn-on threshold voltage, the gate drive voltage V_{SR_GS1} starts to increase, and the secondary switch SR1 is turned on for the first time. When the current I_{SR1} flowing through the secondary switch SR1 decreases to zero at time t3, the secondary switch SR1 is turned off for the first time, and a first stop point is determined. The time when the current flowing through the secondary switch SR1 crosses zero may be referred to as the first stop point.

In boundary current mode, the secondary switch SR1 is turned on at the boundary point (i.e., time t3), the current I_{SR1} flowing through the secondary switch SR1 becomes negative. After a second ON-time T_{ZVS1}, the secondary switch SR1 is turned off again at time t4. At time t5, the primary switch SP1 is turned on and the new first start point is determined. The new switching cycle of the first switching converter 101 starts.

The time indication pulse signal IO has the first level and the second level. The first level width IO_L represents the first duration T_{PS1} from the first start point (e.g., t1) when the primary switch SP1 is turned on to the first stop point (e.g., t3) when the current flowing through the secondary switch SR1 crosses zero. The second level width IO_H represents a second duration Δt₁ from the first stop point (e.g., t3) to the next first start point (e.g., t5).

For the second switching converter 102, as shown in FIG. 3, the primary switch SP2 is turned on from time ta, the current flowing through the primary switch SP2 is increased, the second current sense signal V_{CS2} increases accordingly. The voltage V_{sec_DS2} across the secondary switch SR2 is increased to its plateau voltage when the primary switch SP2 is turned on at time ta. The time when the primary switch SP2 is turned on may be referred to as a second start point, and the second start point is determined.

Referring still to FIG. 3, at time tb, the second current sense signal V_{CS2} increases to the first threshold voltage VTH1, the primary switch SP2 is turned off. The voltage V_{sec_DS1} across the secondary switch SR1 is thus decreased. When the voltage V_{sec_DS1} is decreased to a turn-on threshold voltage of the secondary switch SR2, the gate drive voltage V_{SR_GS2} starts to increase, and the secondary switch SR2 is turned on for the first time. When the current I_{SR2} flowing through the secondary switch SR2 decreases to zero at time tc, the secondary switch SR2 is turned off for the first time, and a second stop point is determined. In boundary current mode, the secondary switch SR2 is turned on at the boundary point (i.e., time tc), the current I_{SR2} flowing through the secondary switch SR2 becomes negative. After a second ON-time T_{ZVS}, the secondary switch SR2 is turned off again at time td. At time the, the primary switch SP2 is turned on for a new switching cycle of the second switching converter 102, and a new second start point is determined.

In addition, the second integrated control circuit 104 further comprise a first circuit, a second circuit and an ON-time control circuit. The first circuit is configured to capture a third duration T_{PS2} between the second start point (e.g., time ta) when the primary switch SP2 is turned on and the second stop point (e.g., time tc) when the current flowing through the secondary switch SR2 crosses zero. The second circuit is configured to capture a fourth duration Δt₂ between the second stop point (e.g., time tc) and the next second start point (e.g., time the).

The ON-time control circuit is configured to provide an ON-time control signal to turn on the secondary switch SR2 for the second ON-time T_{ZVS} after the second stop point. The second ON-time T_{ZVS} of the next switching cycle is adjusted, based on the second ON-time T_{ZVS} of the current switching cycle, the time indication pulse signal IO, the third duration T_{PS2} and the fourth duration Δt₂, so that the fourth duration Δt₂ of the next switching cycle is adjusted accordingly.

Suppose the power provided by the first switching converter 101 is PA, and the power provided by the second switching converter 102 is PB, when Δt₂/Δt₁=T_{PS2}/T_{PS2}, PA/PB keeps stable, this can meet the desired power distribution requirements. In an embodiment, the second ON-time T_{ZVS} of the secondary switch SR2 is adjusted so that Δt₂/Δt₁ is close to T_{PS2}/T_{PS1}, to achieve the desired power distribution requirements.

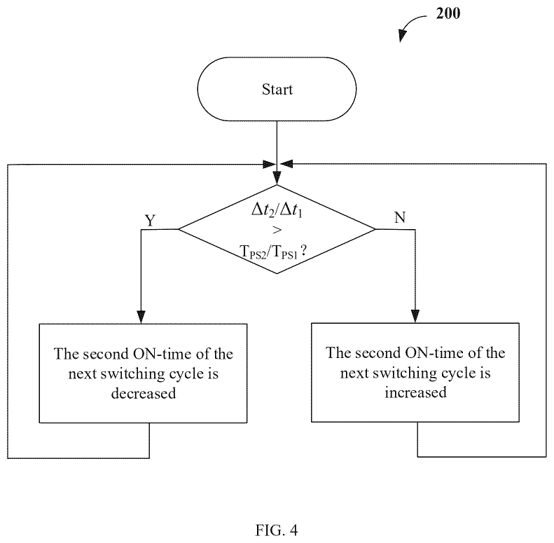

FIG. 4 schematically illustrates a flow diagram of a method 200 of adjusting the second ON-time of the secondary switch SR2 in accordance with an embodiment of the present invention. As shown in FIG. 4, if Δt₂/Δt₁>T_{PS2}/T_{PS1}, the second ON-time T_{ZVS} of the next switching cycle is decreased based on the second ON-time of the current switching cycle. If Δt₂/Δt₁<T_{PS2}/T_{PS1}, the second ON-time T_{ZVS} of the next switching cycle is increased.

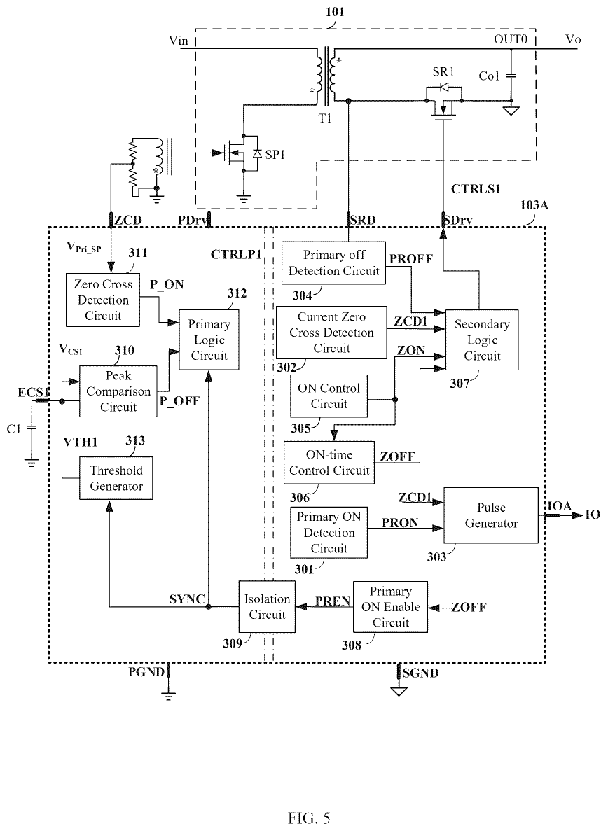

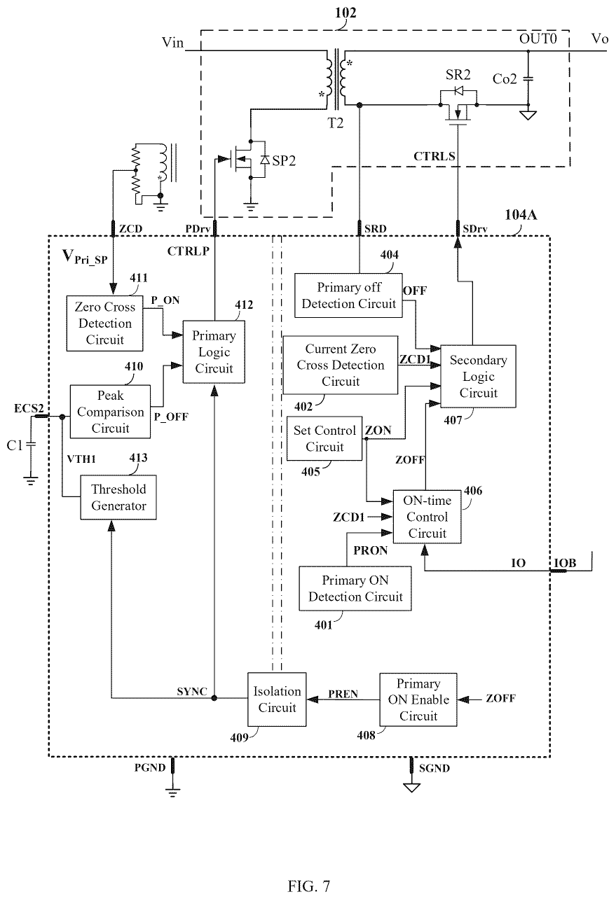

FIG. 5 schematically illustrates a first integrated control circuit 103A configured as the master control circuit in accordance with an embodiment of the present invention. The first integrated control circuit 103A is configured to control the first switching converter 101. In detail, the secondary switch SR1 is controlled to be turned on twice in each switching cycle, and the primary switch SP1 can be configured to be turned on at zero voltage. The first integrated control circuit 103A is further configured to provide the time indication pulse signal IO to the transmission terminal IOA based on the turning-on of the primary switch SP1 and the zero-crossing turning-off of the secondary switch SR1. The transmission terminal IOA in FIG. 5 is coupled to the transmission terminal IOB of the second integrated control circuit 104A shown in FIG. 7.

In the example shown in FIG. 5, the first integrated control circuit 103A comprises a primary ON detection circuit 301, a current zero cross detection circuit 302 and a pulse signal generator 303. The primary ON detection circuit 301 is configured to detect if the primary switch SP1 is turned on and to determine the first start point at which the primary switch SP1 is turned on. The primary ON detection circuit 301 can detect the first start point based on the voltage V_{sec_DS1} across the secondary switch SR1 and/or a voltage across the secondary winding of the transformer T1. In another embodiment, the primary ON detection circuit 301 may capture a signal from the primary side, to detect the turning-on o the primary switch SP1. In an embodiment, the primary ON detection circuit 301 is coupled to a drain terminal of the secondary switch SR1 through a terminal SRD of the first integrated control circuit 101A to receive the voltage V_{sec_DS1} across the secondary switch SR1, and to compare the voltage V_{sec_DS1} with the plateau voltage (labelled as VP) for providing the primary ON detection signal PRON, to determine the first start point.

The current zero cross detection circuit 302 is configured to determine the first stop point at which the current flowing through the secondary switch SR1 crosses zero, and to provide a current zero detection signal ZCD1.

The pulse signal generator 303 is configured to provide the time indication pulse signal IO that becomes the first level at the first start point and becomes the second level at the first stop point.

In the example shown in FIG. 5, the first integrated control circuit 103A further comprises a primary off detection circuit 304, an ON control circuit 305, an ON-time control circuit 306, a secondary logic circuit 307, a primary ON enable circuit 308, an isolation circuit 309, a peak comparison circuit 310, a zero cross detection circuit 311 and a primary logic circuit 312.

The primary off detection circuit 304 is configured to detect if the primary switch SP1 is turned off and to provide a primary off detection signal PROFF. The primary off detection circuit 304 may detect if the primary switch SP1 is turned off based on the voltage V_{sec_DS1} across the secondary switch SR1, the current flowing through the secondary switch SR1, the voltage across the secondary winding of the transformer T1. In another embodiment, the primary off detection circuit 304 may capture a signal from the primary side, to detect the turning-off of the primary switch SP1.

The ON control circuit 305 is coupled to the secondary switch SR1 to detect a resonant voltage of the first switching converter 101 and is configured to provide an ON control signal ZON at a target valley number of the resonant voltage for controlling the turning-on of the secondary switch SR1 after the first stop point, based on the quasi-resonant control. It should understand that one of ordinary skill in the art that the present invention may be practiced in any switching power supply including isolated switching converters in boundary current mode and discontinuous mode. The ON-time control circuit 306 is configured to provide an ON-time control signal ZOFF to control the second ON-time T_{ZVS1}. The secondary switch SR1 is turned off after the second ON-time T_{ZVS1} is exhausted.

In one embodiment, the second ON-time T_{ZVS1} is increased with the decreasing of the output voltage Vo, and is decreased with the increasing of the output voltage Vo. In another embodiment, the second ON-time T_{ZVS1} is increased with the increasing of the input voltage Vin, while is decreased with the decreasing of the input voltage Vin. In one embodiment, the second ON-time T_{ZVS1} is controlled based on the combination of the voltage V_{sec_DS1} across the secondary switch SR1, the output voltage Vo, and the resistance of an external resistor for setting. In other embodiments, the second ON-time T_{ZVS1} may have other generation way which is omitted for clarity.

The secondary logic circuit 307 has a first input terminal, a second input terminal, a third input terminal, a fourth input terminal and an output terminal. The first input terminal of the secondary logic circuit 307 is coupled to the primary off detection circuit 304 to receive the primary off detection signal PROFF. The second input terminal of the secondary logic circuit 307 is coupled to an output terminal of the current zero cross detection circuit 302 to receive the current zero detection signal ZCD1. The third input terminal of the secondary logic circuit 307 is coupled to the ON control circuit 305 to receive the ON control signal ZON. The fourth input terminal of the secondary logic circuit 307 is coupled to the ON time control circuit 306 to receive the ON-time control signal ZOFF. The secondary logic circuit 307 is configured to control the first ON/OFF switching of the secondary switch SR1 based on the primary off detection signal PROFF and the current zero detection signal ZCD1. In addition, the secondary logic circuit 307 is configured to control the second ON/OFF switching of the secondary switch SR1 based on the ON control signal ZON and the ON-time control signal ZOFF.

In the example shown in FIG. 5, the primary ON enable circuit 308 is configured to provide a primary ON enable signal PREN to an input terminal of the isolation circuit 309, when the secondary switch SR1 is turned off after the second on-time T_{ZVS1} of the secondary switch SR1. The isolation circuit 309 has the input terminal configured to receive the primary ON enable signal PREN and an output terminal for outputting a synchronous signal SYNC electrically isolated from the primary ON enable signal PREN. The isolation circuit 309 may comprise opto-coupler, transformer, capacitor or any other suitable electrical isolation device. In other embodiments, the isolation circuit 309 may be located outside of the first integrated control circuit 103A.

The peak comparison circuit 310 has a first input terminal, a second input terminal and an output terminal, wherein the first input terminal is configured to receive the first current sense signal V_{CS1} representative of a current flowing through the primary switch SP1, the second input terminal is configured to receive the first threshold voltage VTH1. The peak comparison circuit 310 is configured to compare the first current sense signal V_{CS1} with the first threshold voltage VTH1, and to provide a peak comparison signal P_OFF at the output terminal.

In the embodiment shown in FIG. 5, the first integrated control circuit 103A further comprises a threshold generator 313. The threshold generator 313 has an input terminal to receive the synchronous signal SYNC and an output terminal for outputting the first threshold voltage VTH1 to the second input terminal of the peak comparison circuit 310, and the first threshold voltage VTH1 is stored in the capacitor C1 coupled to the current reference terminal ECS1 of the first integrated control circuit 103A. In one embodiment, the first threshold voltage VTH1 is related to the synchronous signal SYNC. In other embodiments, the first threshold voltage VTH1 could be a predetermined value and the threshold generator 313 could be omitted.

In one embodiment, the current reference terminal ECS1 of the first integrated control circuit 103A is coupled electrically to the current reference terminal ECS2 of the second integrated control circuit 104B shown in FIG. 7, to share the first threshold voltage VTH1 stored in the capacitor C1. In another embodiment, the first threshold voltage VTH1 is set to be the same predetermined value both in the first integrated control circuit 103A and the second integrated control circuit 104A, and the current reference terminals ECS1 and ECS2 are both omitted.

The zero cross detection circuit 311 is configured to provide a voltage zero-crossing detection signal P_ON by detecting whether a voltage across the primary switch crosses zero or approaches to zero. In an example, the transformer T1 further comprises an auxiliary winding. The zero cross detection circuit 311 is coupled to the auxiliary winding of the transformer T1 through a terminal ZCD. The zero cross detection circuit 311 is configured to receive a sense signal representative of the voltage V_{Pri_SP} across the primary switch SP1, to compare the sense signal with a zero cross threshold V_{ZCD_TH} and to provide the voltage zero-crossing detection signal P_ON at an output terminal. In an embodiment, the zero cross threshold V_{ZCD_TH} is 20 mV. In other embodiments, the zero cross threshold V_{ZCD_TH} could be other appropriate value.

The primary logic circuit 312 is coupled to the output terminal of the isolation circuit 309 to receive the synchronous signal SYNC, is coupled to the zero cross detection circuit 311 to receive the voltage zero-crossing detection signal P_ON, and also is coupled to the peak comparison circuit 310 to receive the peak comparison signal P_OFF. The primary logic circuit 312 is configured to provide a primary control signal CTRLP1 for controlling the primary switch SP1 based on the synchronous signal SYNC, the voltage zero-crossing detection signal P_ON and the peak comparison signal P_OFF. The primary control signal CTRLP1 is provided to the control terminal of the primary switch SP1 through the terminal PDrv. In some embodiment, when the secondary switch SR1 is turned off after the second ON-time T_{ZVS1} is exhausted, the synchronous signal SYNC comes and the voltage V_{Pri_SP} across the primary switch SP1 decreased to reach the zero cross threshold V_{ZCD_TH}, the primary switch SP1 is turned on after an internal delay t_{Delay}, to ensure the primary switch SP1 is turned on at a time in which the voltage V_{Pri_SP} across the primary switch SP1 reaches its optimal minimum value. The delay time t_{Delay} is related to a discharge time of the drain-source capacitor of the primary switch SP1. When the first current sense signal V_{CS1} increases to the first threshold voltage VTH1, the primary switch SP1 is tuned off.

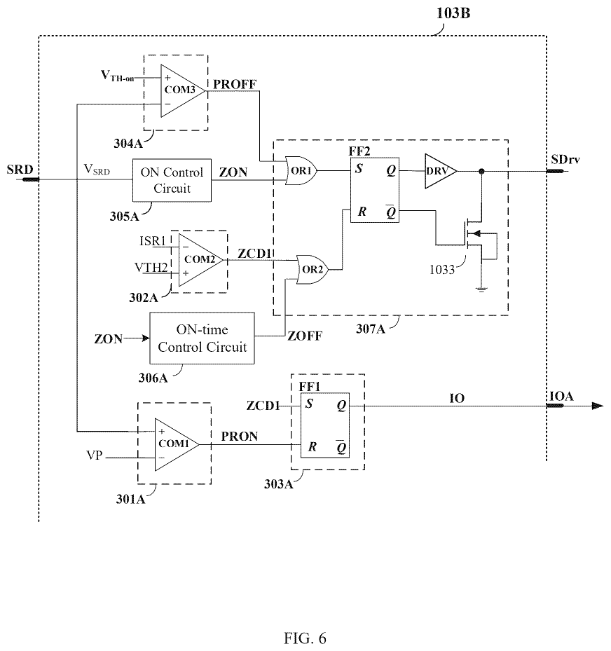

FIG. 6 schematically illustrates a first integrated control circuit 103B configured as a master control circuit in accordance with an embodiment of the present invention. As shown in FIG. 6, the primary ON detection circuit 301A comprises a comparator COM1. The non-inverting input terminal of the comparator COM1 is coupled to the drain terminal of the secondary switch SR1 to receive the voltage V_{sec_DS1} across the secondary switch SR1. The inverting input terminal of the comparator COM1 is configured to receive the plateau voltage VP (e.g., a maximum of the voltage V_{sec_DS1} across the secondary switch SR1). The comparator COM1 provides the primary ON detection signal PRON at the output terminal.

The current zero cross detection circuit 302A comprises a comparator COM2. The inverting input terminal of the comparator COM2 is configured to receive a signal representative the current ISR1 flowing through secondary switch SR1. The non-inverting input terminal of the comparator COM2 is configured to receive a current threshold signal VTH2. The comparator COM2 provides the current zero detection signal ZCD1 at an output terminal. The pulse signal generator 303 comprises a RS flip-flop FF1. The flip-flop FF1 has a setting terminal for receiving the current zero detection signal ZCD1, a resetting terminal for receiving the primary ON detection signal PRON, and an output terminal for providing the time indication pulse signal to the transmission terminal IOA.

In the example shown in FIG. 6, the time indication pulse signal IO becomes the first level at the first start point when the primary switch SP1 is turned on and becomes the second level at the first stop point when the current flowing through the secondary switch SR1 crosses zero. The time indication pulse signal IO is transmitted to the transmission terminal IOB of the second integrated control circuit 104A shown in FIG. 7.

In addition, the primary off detection circuit 304A comprises a comparator COM3. The non-inverting input terminal of the comparator COM3 receives a turn on threshold voltage V_{TH_ON}, the inverting input terminal of the comparator COM3 is coupled to the terminal SRD for receiving the voltage V_{Sec_DS1} across the secondary switch SR1, and the comparator COM3 provides the primary off detection signal PROFF at an output terminal.

The secondary logic circuit 307A comprises logic OR gate circuits OR1 and OR2, a flip-flop FF2, a driving circuit DRV and a discharging circuit 1033. The OR gate circuit OR1 has a first input terminal to receive the primary off detection signal PROFF, a second input terminal to receive the ON control signal ZON, and an output terminal couple to a setting terminal of the flip-flop FF2. The OR gate circuit OR2 has a first input terminal to receive the current zero detection signal ZCD1, a second input terminal to receive the ON-time control signal ZOFF, and an output terminal coupled to a resetting terminal of the flip-flop FF2. The output terminal of the flip-flop FF2 is coupled to the secondary drive terminal SDrv through the driving circuit DRV, to control the secondary switch SR1. The inverting output terminal of the flip-flop FF2 is coupled to a control terminal of the discharging switch 1033 coupled between the secondary drive terminal SDrv and the secondary reference ground SGND, to control the secondary switch SR1.

FIG. 7 schematically illustrates a second integrated control circuit 104A configured as a slave control circuit in accordance with an embodiment of the present invention. The second integrated control circuit 104A is configured to control the second switching converter 102. In detail, the secondary switch SR2 is controlled to be turned on twice in each switching cycle of the secondary switching converter 102, to achieve the zero voltage or near zero voltage turning-on of the primary switch SP2. The second integrated control circuit 104A is configured to adjust the second ON-time T_{ZVS} of the secondary switch SR2 and thus to adjust the fourth duration Δt₂ of the next switching cycle, based on the second start point at which the primary switch SP1 is turned on, the second stop point at which the current flowing through the secondary switch SR2 crosses zero, and the time indication pulse signal IO communicated from the transmission terminal IOA, to meet the power distribution requirements.

Compared with the first integrated control circuit 103A configured as the master control circuit shown in FIG. 5, the second integrated control circuit 104A configured as the slave control circuit can save the pulse generator 303, while the ON-time control circuit 406 further have the configuration to adjust the second ON-time T_{ZVS} of the secondary switch SR2.

When being used in power conversion applications, the first and second integrated control circuits 103a and 104A can both have the circuit blocks including the pulse generator 303 and the ON-time control circuit 406 shown in FIG. 7, it is convenient for users to configure the required circuit blocks according to the practical requirements.

In the example shown in FIG. 7, the second integrated control circuit 104A comprises the first circuit and the second circuit. The first circuit is configured to capture the third duration T_{PS2} between the second start point when the primary switch SP2 is turned on and the second stop point when the current flowing through the secondary switch SR2 crosses zero. The second circuit is configured to capture a fourth duration Δt₂ between the second stop point and the next second start point.

In the example shown in FIG. 7, the second integrated control circuit 104A comprises a primary ON detection circuit 401, a current zero cross detection circuit 402, a primary off detection circuit 404, an ON control circuit 405, an ON-time control circuit 406, a secondary logic circuit 407, a primary ON enable circuit 408, an isolation circuit 409, a peak comparison circuit 410, a zero cross detection circuit 411 and a primary logic circuit 412.

In an embodiment, the primary ON detection circuit 401 is configured to detect if the primary switch SP2 is turned on and to provide the primary ON detection signal PRON, and to determine the second start point. The current zero cross detection circuit 402 is configured to determine the second stop point at which the current flowing through the secondary switch SR2 crosses zero, and to provide a current zero detection signal ZCD1.

The primary off detection circuit 404 is configured to detect if the primary switch SP2 is turned off and to provide a primary off detection signal PROFF. The ON control circuit 405 is coupled to the secondary switch SR2 to detect a resonant voltage of the second switching converter 102, and is configured to provide an ON control signal ZON at a target valley number of the resonant voltage for controlling the turning-on of the secondary switch SR2 after the second stop point, based on the quasi-resonant control. The ON-time control circuit 406 is configured to provide an ON-time control signal ZOFF to control the second ON-time T_{ZVS}. The secondary switch SR2 is turned off after the second ON-time T_{ZVS} is exhausted.

In addition, the ON-time control circuit 406 is configured to adjust the second ON-time T_{ZVS} of the next switching cycle so that Δt₂/Δt₁ is close to T_{PS2}/T_{PS1}, to meet the power distribution requirements.

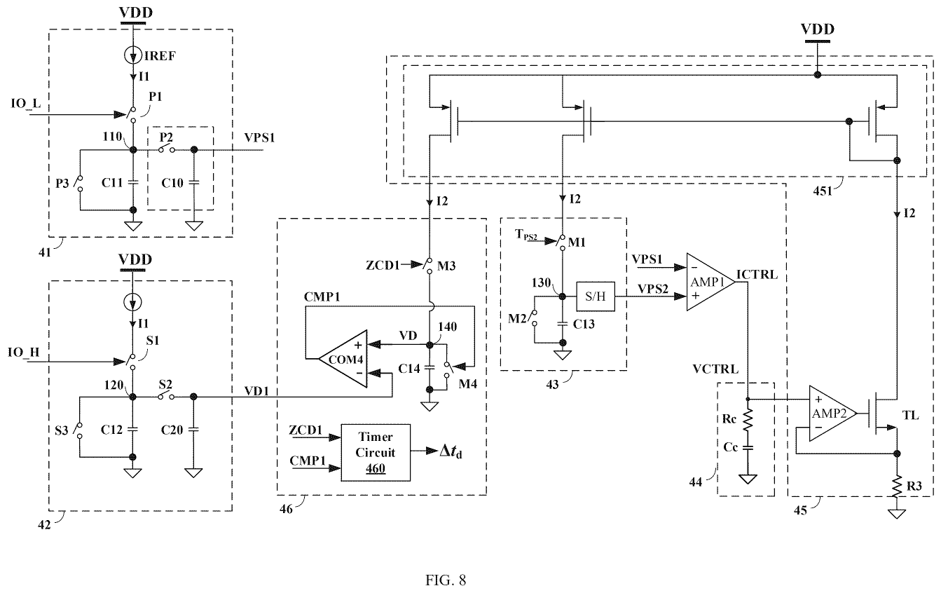

FIG. 8 schematically illustrates an ON-time control circuit 406 of the slave control circuit in accordance with an embodiment of the present invention. In the example shown in FIG. 8, the ON-time control circuit 406 comprises a first time-to-voltage converter circuit 41, a second time-to-voltage converter circuit 42, a third time-to-voltage converter circuit 43, an amplifier AMP1, a compensation circuit 44, a voltage-to-current converter circuit 45 and a third circuit 46.

The first time-to-voltage converter circuit 41 is configured to induce a first voltage signal VPS1 proportional to the first level width IO_L by sourcing with a first driving current I1. In the example shown in FIG. 8, the first time-to-voltage converter circuit 41 comprises a reference current source IREF for providing the first driving current I1, a capacitor C11 and a capacitor C10. The capacitor C11 is coupled to the reference current source IREF, is configured to charge the capacitor C11 through a switch P1 under the control of the first level width IO_L of the time indication pulse signal IO, and the first voltage signal VPS1 is provided. The first time-to-voltage converter circuit 41 further has a switch P2 that is configured to control the charge to be transferred from the capacitor C11 to the capacitor C10, to sample and hold the first voltage signal VPS1. The first time-to-voltage converter circuit 41 further has a switch P3 that is configured to control the capacitor C10 to be discharged and to be reset in each switching cycle.

Similarly, the second time-to-voltage converter circuit 42 is configured to induce a second voltage signal VD1 proportional to the second level width IO_H by sourcing with the first driving current I1. In the example shown in FIG. 8, the first time-to-voltage converter circuit 41 comprises the reference current source IREF, a capacitor C12, a capacitor C20 and the switches S1˜S3. The second time-to-voltage converter circuit 42 operates generally similarly as first time-to-voltage converter circuit 41. As a result, operation of the second time-to-voltage converter circuit 42 is omitted for clarity.

The third time-to-voltage converter circuit 43 is configured to induce a third voltage signal VPS2 proportional to the third duration T_{PS2} by sourcing with a second driving current I2 provided by the voltage-to-current converter circuit 45. The third time-to-voltage converter circuit 43 comprises a capacitor C13, a charging switch M1, a discharging switch M2 and a sample-and-hold circuit S/H.

The amplifier AMP1 has an inverting input terminal to receive the first voltage signal VPS1 and a non-inverting input terminal to receive the third voltage signal VPS2. The amplifier AMP1 is configured to provide a control current ICTRL at an output terminal based a voltage difference between the first voltage signal VPS1 and the third voltage signal VPS2. The compensation circuit 44 is coupled to the output terminal of the amplifier AMP1 and is configured to provide a control voltage VCTRL based on the control current ICTRL. In the example shown in FIG. 8, the compensation circuit 44 is coupled between the output terminal of the amplifier AMP1 and the secondary reference ground SGND. The compensation circuit 44 is made up of a compensation capacitor Cc and a compensation resistor Rc coupled in series.

The voltage-to-current converter circuit 45 is configured to provide the second driving current I2 based on the control voltage VCTRL. In the example shown in FIG. 8, The voltage-to-current converter circuit 45 comprises an amplifier AMP2, a transistor TL, a resistor R3 and a current mirror 451. The third circuit 46 is configured to provide a target voltage signal VD by sourcing with the second driving current I2 from the second start point and to determine a target time point at which the target voltage signal VD increases to reach the second voltage signal VD1, and further to capture a target duration Δt_{d} between the second stop point and the target time point. The third circuit 46 comprises a capacitor C14, a comparator COM4, switches M3 and M4, and a timer circuit 460. When the current flowing through the secondary switch SR2 crosses zero, the switch M3 is turned on to charge the capacitor C14 with the second driving current I2, and the target voltage signal VD increases gradually. When the target voltage signal VD is increased to reach the second voltage signal VD1, the comparator COM4 provides a comparison signal CMP1 to determine the target time point. The timer circuit 460 receives the current zero detection signal ZCD1 and the comparison signal CMP1, and is configured to capture the target duration Δt_{d} between the second stop point and the target time point.

Furthermore, the ON-time control circuit 406 comprises a process unit that is configured to adjust the second ON-time T_{ZVS} of the next switching cycle, based on the second ON-time T_{ZVS} of the current switching cycle, the fourth duration Δt₂ and the target duration Δt_{d}. In detail, when the target duration Δt_{d} is longer than the fourth duration Δt₂, the second ON-time T_{ZVS} of the next switching cycle is increased by an increment (e.g., 50 nS) based on the second ON-time T_{ZVS} of the current switching cycle. When the target duration Δt_{d} is shorter than the fourth duration Δt₂, the second ON-time T_{ZVS} of the next switching cycle is decreased by a decrement (e.g., 50 nS) based on the second ON-time T_{ZVS} of the current switching cycle.

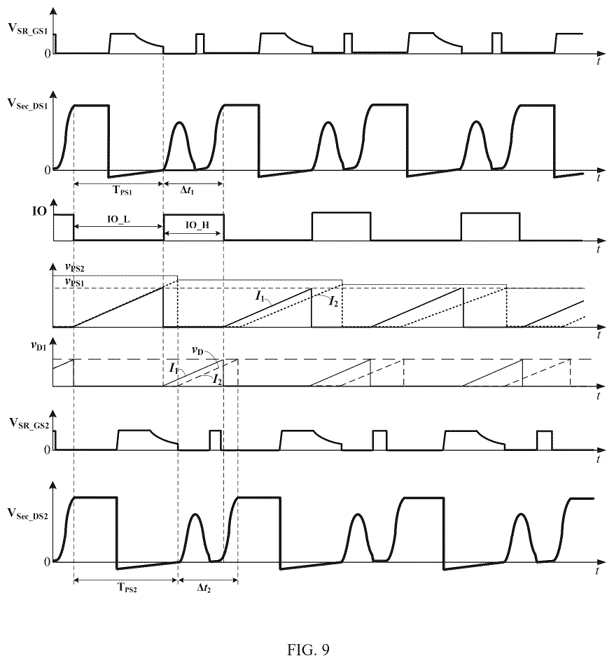

FIG. 9 schematically illustrates a working waveform diagram of the switching power supply 100 operating in discontinuous current mode in accordance with an embodiment of the present invention. As shown in FIG. 9, the secondary switch SR1 is turned on twice in a switching cycle. The time indication pulse signal IO provided by the first integrated control circuit 103A has the first level width IO_L and the second level width IO_H. The first level width IO_L represents the first duration T_{PS1} from the first start point when the primary switch SP1 is turned on to the first stop point when the current flowing through the secondary switch SR1 crosses zero. The second level width IO_H represents a second duration Δt₁ from the first stop point to the next first start point

In the second integrated control circuit 104A, the first voltage signal VPS1 is proportional to the first level width IO_L of the time indication pulse signal IO, the proportionality coefficient is determined by the first driving current I1. The second voltage signal VD1 is proportional to the second level width IO_H of the time indication pulse signal IO, and the proportionality coefficient is determined by the first driving current I1. The third voltage signal VPS2 is proportional to the third duration TPS2, and the proportionality coefficient is determined by the second driving current I2. As discussed above, the second driving current I2 is adjusted by the amplifier AMP1, to make the third voltage signal VPS2 to approach the first voltage signal VPS1. In addition, the second ON-time T_{ZVS1} of the secondary switch SR1 is not affected by the second integrated control circuit 104A, while the second ON-time T_{ZVS} of the secondary switch SR2 needs to be adjusted to change the fourth duration Δt₂ so that Δt₂/Δt₁ is close to T_{PS2}/T_{PS1}, to meet the power distribution requirements.

In an embodiment, if the accumulated increment to the second ON-time T_{ZVS} of the secondary switch SR2 reaches a pre-determined maximum value and Δt₂/Δt₁ is still less than T_{PS2}/T_{PS1}, a delay time is inserted to postpone the turning-on of the secondary switch SR2 after the second stop point. In a further embodiment, if the accumulated decrement reaches the pre-determined maximum value and Δt₂/Δt₁ is still higher than T_{PS2}/T_{PS1}, the inserted delay time is removed.

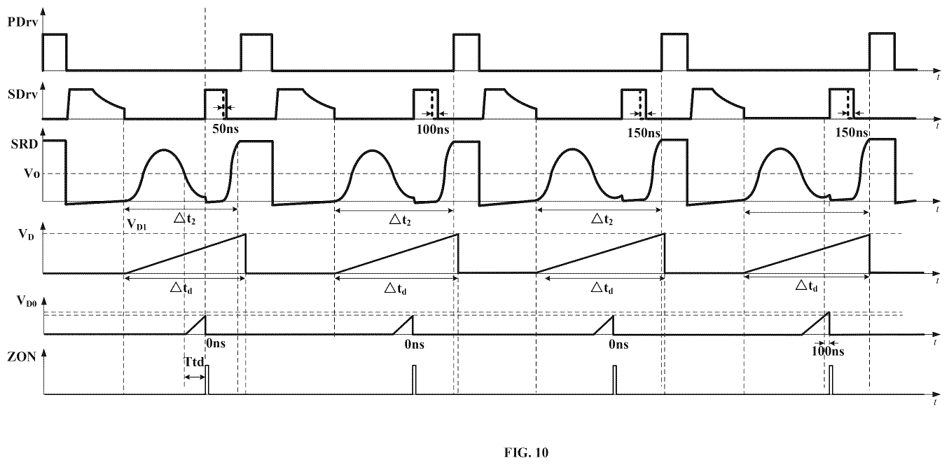

FIG. 10 schematically illustrates a working waveform diagram of the second switching converter 102 operating in discontinuous current mode in accordance with another embodiment of the present invention.

As shown in FIG. 10, when the accumulated increment to the second ON-time T_{ZVS} of the secondary switch SR2 reaches the pre-determined maximum value and the target duration Δt_{d} is still higher than the fourth duration Δt₂, a preset delay time is inserted to postpone the turning-on of the secondary switch SR2 after the second stop point, i.e., the setting logic state of the ON control signal ZON is delayed by the delay time.

As shown in FIG. 10, the secondary switch SR2 is turned on again after a predetermined time duration Ttd from a cross-point at which the voltage V_{sec_DS1} decreases to the output voltage Vo, the ON control signal ZON with the setting logic state is generated, and the secondary switch SR2 is turned on again. Since the target duration Δt_{d} is higher than the fourth duration Δt₂ in several continuous switching cycles, the second ON-time T_{ZVS} is controlled to increase by the increment (e.g., 50 ns) in each switching cycle of the continuous switching cycles.

When the accumulated increment to the second ON-time T_{ZVS} of the secondary switch SR2 reaches the pre-determined maximum value (e.g., 150 ns) and the target duration Δt_{d} is still higher than the fourth duration Δt₂, a delay time (e.g., 100 ns) is inserted to postpone the turning-on of the secondary switch SR2.

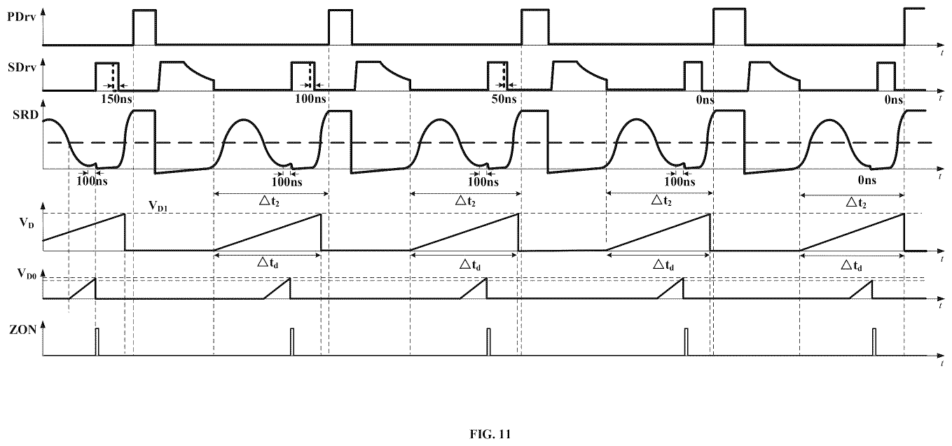

FIG. 11 shows a working waveform diagram of the second switching converter 102 operating in discontinuous current mode in accordance with yet another embodiment of the present invention.

In the example shown in FIG. 11, when the accumulated decrement reaches the pre-determined maximum value in the continuous switching cycles, for example, from 150 ns decreasing to 0 ns, and the target duration Δt_{d} is still shorter than the fourth duration Δt₂, the inserted delay time (e.g., 100 ns) is removed.

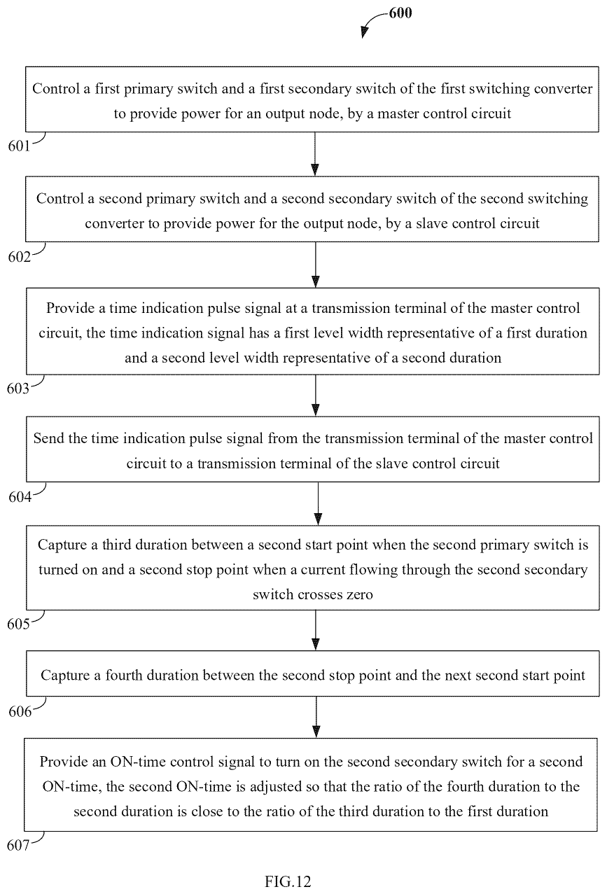

FIG. 12 schematically illustrates a flow diagram of a method 600 for a multi-converter switching power supply in accordance with an embodiment of the present invention. The multi-converter switching power supply has an output node for providing an output voltage. The control method 600 comprises steps 601˜607.

In step 601, a first primary switch and a first secondary switch of the first switching converter are controlled by a master control circuit, to provide power to the output node.

In step 602, a second primary switch and a second secondary switch of the second switching converter are controlled by a slave control circuit, to provide power to the output node.

In step 603, a time indication pulse signal is provided at a transmission terminal of the master control circuit. The time indication pulse signal has a first level width and a second level width. The first level width is representative of a first duration between a first start point and a first stop point. The second level width is representative of a second duration between the first stop point and a next first start point. The first start point is the time point when the first primary switch is turned on. The first stop point is the time point when a current flowing through first secondary switch crosses zero.

In step 604, the time indication pulse signal is sent, from the transmission terminal of the master control circuit to a transmission terminal of the slave control circuit.

In step 605, a third duration between a second start point and a second stop point is captured. The second start point is the time point when the second primary switch is turned on. The second stop point is the time point when a current flowing through the second secondary switch crosses zero.

In step 606, a fourth duration between the second stop point and the next second start point, is captured.

In step 607, an ON-time control signal is provided to turn on the second secondary switch for a second ON-time. The second ON-time is adjusted so that a first ratio of the fourth duration to the second duration is close to a second ratio of the third duration to the first duration.

In an embodiment, if the first ratio is higher than the second ratio, the second ON-time of the next switching cycle is decreased. If the first ratio is less than the second ratio, the second ON-time of the next switching cycle is increased.

In one example, adjusting the second ON-time comprises the following steps. A first voltage signal is induced by using a first driving current, the first voltage signal is proportional to the first level width of the time indication pulse signal. A second voltage signal is induced by using the first driving current, the second voltage signal is proportional to the second level width of the time indication pulse signal. A third voltage signal is induced by using a second driving current, the third voltage signal is proportional to the third duration. A control current is provided based on a voltage difference between the first voltage signal and the third voltage signal. A control voltage is provided based on the control current. A target voltage signal is generated from the second stop point, by using the second driving current, to determine a target time point at which the target voltage signal increases to the second voltage signal. A target duration between the second stop point and the target time point is captured. The second ON-time of the next switching cycle is adjusted based on the second ON-time of the current switching cycle, the fourth duration and the target duration.

In one embodiment, when a first current sense signal representative of a current flowing through the first primary switch reaches a first threshold voltage, the first primary switch is turned off. When a second current sense signal representative of a current flowing through the second primary switch reaches the first threshold voltage, the second primary switch is turned off. In other words, the first switching converter and the second converter share the same first threshold voltage for controlling the turning-off of the first primary switch and the second primary switch.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A switching power supply, comprising:
a first switching converter having a first primary switch and a first secondary switch;
a second switching converter having a second primary switch and a second secondary switch, wherein the first and second switching converters are configured to provide an output voltage to an output node;
a first integrated control circuit having a transmission terminal configured to provide a time indication pulse signal having a first level width and a second level width, wherein the first level width represents a first duration between a first start point when the first primary switch is turned on and a first stop point when a current flowing through the first secondary switch crosses zero, the second level width represents a second duration between the first stop point and a subsequent first start point; and
a second integrated control circuit configured to control the second secondary switch to be turned on twice in a switching cycle, comprising:
a second transmission terminal configured to be coupled to the first transmission terminal for receiving the time indication pulse signal;
a first circuit configured to capture a third duration between a second start point when the second primary switch is turned on and a second stop point when a current flowing through the second secondary switch crosses zero;
a second circuit configured to capture a fourth duration between the second stop point and a subsequent second start point; and
an ON-time control circuit configured to provide an ON-time control signal to turn on the second secondary switch for a second ON-time after the second stop point, wherein the second ON-time is adjusted so that the ratio of the fourth duration to the second duration is close to the ratio of the third duration to the first duration.

2. The switching power supply of claim 1, wherein the ON-time control circuit comprises:
a first time-to-voltage converter circuit configured to induce a first voltage signal proportional to the first level width by using a first driving current;
a second time-to-voltage converter circuit configured to induce a second voltage signal proportional to the second level width by using the first driving current;
a third time-to-voltage converter circuit configured to induce a third voltage signal proportional to the third duration by using a second driving current;
an amplifier having a first input terminal to receive the first voltage signal and a second input terminal to receive the third voltage signal, and configured to provide a control current at an output terminal based a voltage difference between the first voltage signal and the third voltage signal;
a compensation circuit coupled to the output terminal of the amplifier and configured to provide a control voltage based on the control current;
a voltage-to-current converter circuit configured to provide the second driving current based on the control voltage;
a third circuit configured to provide a target voltage signal by using the second driving current from the second start point and configured to determine a target time point at which the target voltage signal increases to reach the second voltage signal, and further to capture a target duration between the second stop point and the target time point; and
a process unit configured to adjust the second ON-time of the next switching cycle, based on the second ON-time of the current switching cycle, the fourth duration and the target duration.

3. The switching power supply of claim 2, wherein:
the second ON-time of the next switching cycle is increased by an increment when the target duration is longer than the fourth duration; and
the second ON-time of the next switching cycle is decreased by a decrement when the target duration is shorter than the fourth duration.

4. The switching power supply of claim 3, wherein when the accumulated increment reaches a pre-determined maximum value and the target duration is longer than the fourth duration, a delay time is inserted to postpone the turning-on of the second secondary switch after the second stop point.

5. The switching power supply of claim 4, wherein when the accumulated decrement reaches the pre-determined maximum value and the target duration is shorter than the fourth duration, the inserted delay time is removed.

6. The switching power supply of claim 1, wherein the first switching converter and the second switching converter operate in boundary current mode or discontinuous current mode.

7. The switching power supply of claim 1, wherein:
when a first current sense signal representative of a current flowing through the first primary switch reaches a first threshold voltage, the first primary switch is turned off; and
when a second current sense signal representative of a current flowing through the second primary switch reaches the first threshold voltage, the second primary switch is turned off.

8. An integrated control circuit for a switching converter with a primary switch and a secondary switch, comprising:
a transmission terminal configured to provide a time indication pulse signal having a first level width and a second level width, wherein the first level width represents a first duration between a first start point when the primary switch is turned on and a first stop point when a current flowing through the secondary switch crosses zero, and the second level width represents a second duration between the first stop point and a subsequent first start point;
a current reference terminal configured to share a first threshold voltage with a slave control circuit; and
a peak comparison circuit configured to compare a current sense signal indicative of a current flowing through the primary switch with the first threshold voltage, and to provide a peak comparison signal to control the turning-off of the primary switch based on the comparison.

9. The integrated control circuit of claim 8, comprises:
a primary ON detection circuit configured to determine the first start point;
a current zero cross detection circuit configured to determine the first stop point; and
a pulse signal generator configured to provide the time indication pulse signal that becomes the first level at the first start point and becomes the second level at the first stop point.

10. The integrated control circuit of claim 9, further comprising:
a primary off detection circuit configured to detect if the primary switch is off and to provide a primary off detection signal;
an ON control circuit coupled to the secondary switch to detect a resonant voltage of the switching converter and configured to provide an ON control signal at a target valley number of the resonant voltage;
an ON-time control circuit configured to provide an ON-time control signal to turn on the second secondary switch for a second ON-time after the first stop point; and
a secondary logic circuit configured to provide a secondary control signal based on the primary off detection signal, the ON control signal and the ON-time control signal.

11. The integrated control circuit of claim 10, further comprising:
a primary ON enable circuit configured to provide a primary ON enable signal when the secondary switch is turned off after the second ON-time of the secondary switch;
an isolation circuit having an input terminal configured to receive the primary ON enable signal and an output terminal for outputting a synchronous signal electrically isolated from the primary ON enable signal;
a zero cross detection circuit configured to provide a voltage zero-crossing detection signal by detecting whether a voltage across the primary switch crosses a zero-crossing threshold voltage; and
a primary logic circuit configured to provide a primary control signal for controlling the primary switch based on the synchronous signal and the voltage zero-crossing detection signal.

12. The integrated control circuit of claim 10, wherein the switching converter operates in boundary current mode or discontinuous mode.

13. An integrated control circuit for a switching converter with a primary switch and a secondary switch, comprising:
a transmission terminal capable of receiving a time indication pulse signal from a master control circuit, the time indication pulse signal has a first level width representative of a first duration and a second level width representative of a second duration;
a first circuit configured to capture a third duration between a second start point when the primary switch is turned on and a second stop point when a current flowing through the secondary switch crosses zero;
a second circuit configured to capture a fourth duration between the second stop point and a subsequent second start point; and
an ON-time control circuit configured to provide an ON-time control signal to turn on the secondary switch for a second ON-time, wherein the second ON-time is adjusted based on the time indication pulse signal, the third duration and the fourth duration.

14. The integrated control circuit of claim 13, further comprising:
a current reference terminal configured to share a first threshold voltage with a master control circuit; and
a peak comparison circuit configured to compare a current sense signal indicative of a current flowing through the primary switch with the first threshold voltage and to provide a peak comparison signal to control the turning-off of the primary switch based on the comparison.

15. The integrated control circuit of claim 13, wherein the second ON-time is adjusted so that a first ratio of the fourth duration to the second duration is close to a second ratio of the third duration to the first duration.

16. The integrated control circuit of claim 15, wherein the ON-time control circuit comprises:
a first time-to-voltage converter circuit configured to induce a first voltage signal proportional to the first level width by using a first driving current;
a second time-to-voltage converter circuit configured to induce a second voltage signal proportional to the second level width by using the first driving current;
a third time-to-voltage converter circuit configured to induce a third voltage signal proportional to the third duration by using a second driving current;
an amplifier having a first input terminal to receive the first voltage signal and a second input terminal to receive the third voltage signal, and configured to provide a control current at an output terminal based a voltage difference between the first voltage signal and the third voltage signal;
a compensation circuit coupled to the output terminal of the amplifier and configured to provide a control voltage based on the control current;
a voltage-to-current converter circuit configured to provide the second driving current based on the control voltage;
a third circuit configured to provide a target voltage signal by using the second driving current from the second start point and configured to determine a target time point, at which the target voltage signal increases to reach the second voltage signal, and further to capture a target duration between the second stop point and the target time point; and
a process unit configured to adjust the second ON-time of the next switching cycle, based on the second ON-time of the current switching cycle, the fourth duration and the target duration.

17. The integrated control circuit of claim 15, wherein:
if the first ratio is higher than the second ratio, the second ON-time of the next switching cycle is decreased; and
if the first ratio is less than the second ratio, the second ON-time of the next switching cycle is increased.

18. The integrated control circuit of claim 15, further comprising:
a primary off detection circuit configured to detect if the primary switch is off and to provide a primary off detection signal;
a current zero cross detection circuit configured to determine the second stop point at which the current flowing through the secondary switch crosses zero; and
an ON control circuit coupled to the secondary switch to detect a resonant voltage of the switching converter and configured to provide an ON control signal at a target valley number of the resonant voltage; and
a secondary logic circuit configured to provide a secondary control signal based on the primary off detection signal, the ON control signal and the ON-time control signal.

19. The integrated control circuit of claim 17, wherein:
when the accumulated increment reaches a pre-determined maximum value and the first ratio is less than the second ratio, a delay time is inserted to postpone the turning-on of the secondary switch after the second stop point; and
when the accumulated decrement reaches the pre-determined maximum value and the first ratio is higher than the second ratio, the inserted delay time is removed.

20. A control method for a multi-converter switching power supply for providing an output voltage, comprising:
engaging a master control circuit to control a first primary switch and a first secondary switch of a first switching converter;
engaging a slave control circuit to control a second primary switch and a second secondary switch of a second switching converter;
sending a time indication pulse signal having a first level width and a second level width at a transmission terminal of the master control circuit, wherein the first level width represents a first duration between a first start point when the first primary switch is turned on and a first stop point when a current flowing through the first secondary switch crosses zero, and the second level width represents a second duration between the first stop point and a subsequent first start point;
receiving the time indication pulse signal at a transmission terminal of the slave control circuit;
capturing a third duration between a second start point when the second primary switch is turned on and a second stop point when a current flowing through the second secondary switch crosses zero;
capturing a fourth duration between the second stop point and a subsequent second start point; and
providing an ON time control signal to turn on the second secondary switch for a second ON-time, wherein the second ON-time is adjusted so that a first ratio of the fourth duration to the second duration is close to a second ratio of the third duration to the first duration.

21. The control method of claim 20, wherein the first switching converter and the second switching converter have the same first threshold voltage, and wherein:
when a first current sense signal representative of a current flowing through the first primary switch reaches the first threshold voltage, the first primary switch is turned off; and
when a second current sense signal representative of a current flowing through the second primary switch reaches the first threshold voltage, the second primary switch is turned off.

22. The control method of claim 21, wherein:
inducing a first voltage signal by using a first driving current, wherein the first voltage signal is proportional to the first level width of the time indication pulse signal;
inducing a second voltage signal by using the first driving current, wherein the second voltage signal is proportional to the second level width of the time indication pulse signal;
inducing a third voltage signal by using a second driving current, wherein the third voltage signal is proportional to the third duration;
providing a control current based on a voltage difference between the first voltage signal and the third voltage signal;
providing a control voltage based on the control current;
providing the second driving current based on the control voltage;
from the second stop point, generating a target voltage signal by using the second driving current, to determine a target time point at which the target voltage signal increases to the second voltage signal;
capturing a target duration between the second stop point and the target time point; and
adjusting the second ON-time of the next switching cycle based on the second ON-time of the current switching cycle, the fourth duration and the target duration.

23. The control method of claim 21, wherein:
if the first ratio is higher than the second ratio, the second ON-time of the next switching cycle is decreased; and
if the first ratio is less than the second ratio, the second ON-time of the next switching cycle is increased.
